(19) United States
(12) Patent Application Publication
(10) Pub. No.: US 2007/0178716 A1
(43) Pub. Date: Aug. 2, 2007

(54) Modular microelectronic-system for use in wearable electronics

(76) Inventors: Rupert Hermann Josef Glaser, Munich (DE); Stefan Jung, Munich (DE); Christl Lauterbach, Hoehenkirchen-Siegertsbrunn (DE)

Correspondence Address: FISH & RICHARDSON P.C., P.O. BOX 1022, MINNEAPOLIS, MN, 55440-1022, US

(21) Appl. No.: 10/561,177

(22) PCT Filed: Jun. 22, 2004
(86) PCT No.: PCT/EP04/06745

§ 371 Date: Jun. 30, 2006

(30) Foreign Application Priority Data
Jun. 24, 2003 (DE) 103-28-359.5

(51) Int. Cl. H01R 33/00

(52) U.S. Cl. 439/37

(57) ABSTRACT

The invention relates to a modular microelectronic-system comprising: a first connection module (12) which can be firmly connected to user interface devices integrated textile material; and a second connection module (14) which comprises user interface devices (24, 26) and/or which an be connected to an external device; in addition to an electronic module (10) which can be connected to the first connection module (12) or to the second connection module (14).

The present invention relates to a modular microelectronic system pursuant to claim 1.

To an increasing extent, consumers are expressing a demand for clothing and accessories that, in addition to performing their traditional functions such as providing warmth, protection and status, can also perform supplemental electronic functions. Many conceivable applications for intelligent clothing (smart clothes) can be realized by integrating electronic components and modules into textiles.

For example, the technique is known whereby everyday devices such as mobile telephones, GPS units and MP-3 players, for example, are sewn into clothing, and connecting wires are provided within a type of textile cable conduit in clothing made especially for this purpose. These known arrangements, however, have the disadvantage that the devices must be removed from the clothing for washing, and once the articles of clothing have been dried, the devices must be reinserted. The state-of-the-art arrangements offer the further disadvantage that if one forgets to remove the device prior to washing, the washing process may damage the device.

It is thus an objective of the present invention to provide a microelectronic system that is easy to manipulate.

This objective is attained in accordance with the present invention with a microelectronic system having the characterizing features disclosed in claim 1. Preferred exemplary embodiments are contained in the dependent claims.

According to the invention, a microelectronic system is provided, comprising
a first connection module, which can be firmly connected to user interface devices integrated into a textile material; and
a second connection module, which comprises user interface devices and/or which can be connected to an external device; and
an electronic module, which can be connected to the first connection module or to the second connection module.

The user interface devices preferably comprise, for example, control elements for the electronic module, acoustic input and output devices, such as headphones and microphones, etc. Electrical connecting cables or wires are preferably arranged in the textile material, for example woven into it, and are connected to the user interface devices. The textile material is preferably designed in the form of an article of clothing. During use, the first connection module is connected to the electrical connecting cables in the textile material, for example by soldering, welding, crimping or via a conductive adhesive.

The user interface devices of the second connection module preferably comprise control buttons or elements, a display, acoustic input and output devices, such as microphones and a headphone connector, for example. The user interface devices of the second connection module are intended especially to control the functions of the electronic module. When the electronic module is connected to the second connection module, an independent operation of the electronic module or a so-called “stand-alone operation” of the electronic module is enabled.

The external device is preferably a computer or a connector power pack.

The electronic module preferably has no user interface devices.

Preferably the electronic module comprises a processor element, a power supply unit or power storage unit or a rechargeable battery or a battery and a junction unit for connection to one of the connection modules.

The processor element preferably comprises all the electronics required for the functioning of the electronic module, and a read-only memory.

Preferably, the electronic module is designed to be essentially waterproof.

In this manner, damage to the electronic module caused during the washing of the textile material when the module is attached to the textile material is prevented.

In one preferred embodiment, the electronic module comprises an identification device designed to recognize which connection module the electronic module is connected to in its connected state.

Preferably the two connection modules can at least partially comprise different control or output elements. With the identification device, the electronic module can recognize which connection module it is connected to, allowing it to react to the various functions.

Preferably the first connection module and the second connection module each comprise a junction unit that fits with the junction unit of the electronic module.

The first connection module is preferably designed to be essentially waterproof.

In one preferred embodiment, the first connection module can be connected to the textile material by means of a connecting device.

The first connection module is preferably placed in electrical contact via the electrical connecting cables arranged in the textile material. A mounting device is preferably provided to enable an improved mechanical support of the first connection module on the textile material. The mounting device is preferably a plate to be glued, a device to be sewn, or a buckle to be attached to a support band.

The second connection module is preferably designed such that when the second connection module is connected to an external device, a charging of the power supply unit for the electronic module and/or a transfer of data to and/or from the electronic module is enabled.

When the second connection module is connected to an external device, preferably a computer, the second connection module preferably performs the function of a so-called “docking station” via which the electronic module can be charged and data can be transferred.

The system further preferably comprises a charging device for charging the power supply unit of the electronic module, which can be connected to the electronic module and/or to the second connection module.

With the addition of the charging device, it is not necessary for the power supply unit of the electronic module to be charged via, for example, a connected computer. In this case the power supply or the charging can be accomplished directly via the charging device or indirectly via the second connection module.

Further characterizing features, objectives and advantages of the present invention are apparent from the following description with reference to the drawing. Specifically, the drawing shows a schematic view of a microelectronic system pursuant to one preferred embodiment of the present invention.

The microelectronic system pursuant to the preferred embodiment comprises an electronic module 10, a first connection module 12 and a second connection module 14.

The electronic module 10 comprises essentially all the electronics necessary for the functioning of the electronic module, a rechargeable battery or a battery or a power storage unit or power supply unit, a read-only memory and a junction device or a connector for connecting with one of the two other modules 12, 14. For example, the electronic module 10 can comprise components designed to make up an MP-3 player or a mobile telephone.

Preferably, no user interfaces are provided in the electronic module 10. The electronic module 10, as is described further below, is controlled via one of the connection modules 12, 14.

The electronic module 10 can further comprise an identification device, by means of which it can be determined whether the electronic module 10 is connected to the first connection module 12 or to the second connection module 14.

The electronic module 10 is preferably sealed or molded to be waterproof, so that it will not be damaged by contact with water. Further, the electronic module preferably comprises a sealing ring 18.

The first connection module 12 is intended for permanent integration in a textile article of clothing (so-called “wearable electronics”). In this arrangement, electrical connecting cables or wires are arranged in the textile material, for example woven in, and establish an electrical connection between the first connection module 12 and user interface devices, such as headphones, control elements, or microphones, for example. The user interface devices also are preferably integrated into the textile article of clothing. The first connection module 12 is preferably placed in contact with the electrical connecting cables of the textile material by means of soldering or with the help of a conductive adhesive.

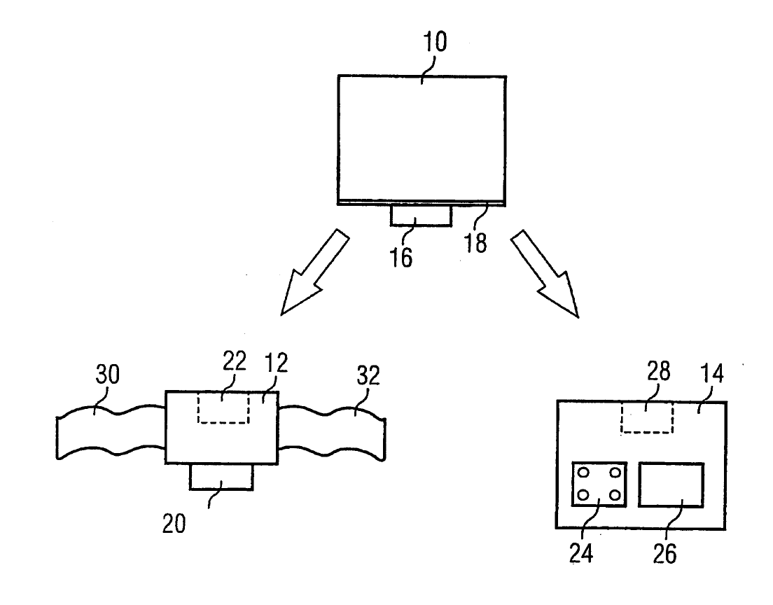

The first connection module 12 preferably contains no electronics, and instead forms an interface or a junction point between the electrical connecting cables or the user interface devices arranged in the textile material and the electronic module 10. The electrical connecting cables are preferably designed as textile cables. In the drawing, the reference FIG. 30 refers to a textile cable, for example for audio, and the reference FIG. 32 refers to a textile cable, for example for a keypad.

The first connection module 12 further comprises a mounting device 20 for connecting the first connection module 12 to the textile material. The mounting device 20 can be a plate for gluing, a device for sewing or a buckle for attachment to a support band. With the mounting device 20, a firm or stable mechanical attachment of the first connection module 12 to the textile material can be achieved.

The first connection module 12 also comprises a junction unit or socket 22, which is designed to accommodate the connector 16 of the electronic module 10.

The first connection module 12 is preferably also sealed or molded to be waterproof, and when the textile material is being washed, the module is designed to remain in it. The junction between the first connection module 12 and the electrical connecting cables is also designed to be waterproof or protected from water.

The second connection module 14 comprises user interface devices such as control elements 24 for operating the electronic module 10, a display 26 and a socket (not shown here) for a headphone connector or similar device. Furthermore, the second connection module 14 may also have a charging device for a rechargeable battery, for charging the rechargeable battery of the electronic module 10. The user interface devices provided in the second connection module 14 can correspond to the user interface devices of the textile article of clothing, or additional devices may also be provided.

The second connection module 14 is preferably further designed as a sort of “docking station”. In this design, the second connection module 14 can be connected to a computer or some other suitable external device, preferably via a serial interface (not shown here), such as a USB interface, for example. In this manner, for example, data can be exchanged between the electronic module 10 and the computer, or the rechargeable battery of the electronic module 10 can be charged.

The second connection module 14 further comprises a junction unit or socket 28 for establishing a connection with the electronic module 10.

It is not necessary for the second connection module 14 to be designed to be waterproof or washable.

It is not necessary for the first connection module 12 and the second connection module 14 to have the same profile. Thus, for example, the first connection module 12 can be designed to be smaller than the second connection module 14.

In addition to the three described components, in the system pursuant to the preferred embodiment of the invention a battery charging station (not shown here) can be provided, to allow the rechargeable battery of the electronic module 10 to be charged directly via the second connection module 14.

Below, the operation of the microelectronic system will be described.

The electronic module 10 can be connected either to the first connection module 12 or to the second connection module 14. First, the operation of the system when the electronic module 10 is connected to the first connection module 12 will be described.

In this arrangement, the connector 16 is locked in place in the socket 22. A supplementary locking device (not shown here) is preferably provided, which establishes a stable mechanical connection between the electronic module 10 and the first connection module 12. The sealing ring 18 enables an essentially waterproof or watertight connection between the electronic module 10 and the first connection module 12, so that no water can penetrate into the connection area. Alternatively, the sealing ring 18 may be omitted and the junction devices 16, 22 can be designed such that if they should come into contact with water no impairment of their functioning will result.

When the electronic module 10 and the first connection module 12 are connected to one another, the electronic module 10 can be controlled by means of the control devices, for example a touch pad, arranged in the textile fabric. Further, an acoustic output via headphones and/or an acoustic input via microphones can take place. For example, the electronic module 10 may function as an MP-3 player or a mobile telephone.

The electronic module 10 can be integrated in a simple manner into the textile article of clothing, and can be controlled by means of the control elements integrated into the article of clothing.

When the article of clothing is being washed, the electronic module 10, which is designed to be waterproof, can remain in the article of clothing. Further, the electronic module 10 can easily be removed as a result of its connection via the connector 16 and socket 22.

Below, the operation of the system when the electronic module 10 is connected to the second connection module 14 will be described.

The socket 28 is essentially the same in design as the socket 22 of the first connection module 12. Here again, a supplementary locking device that is not shown here may also be provided. The connector 16 is locked in the socket 28, creating a stable mechanical connection between the electronic module 10 and the second connection module 14.

The second connection module 14 preferably has two functions.

First, using the second connection module 14 a stand-alone operation of the electronic module 10, i.e. an operation without the article of clothing, Is enabled. In this case the electronic module 10 is controlled by means of the control elements 24, and an acoustic output can be produced, for example, via headphones.

Second, the second connection module 14 can be connected to a computer, for example via a serial interface (not shown here). In this operating mode data can be exchanged from and to the electronic module 10 and the computer. In addition, the rechargeable battery of the electronic module 10 can also be charged. It is also conceivable for the electronic module 10 to be controlled by means of control elements contained in the computer.

In addition, the same serial interface can be used to connect a connector power pack, allowing the rechargeable battery to be charged without the computer.

With the help of the identification device, the electronic module 10 can determine which connection module it is connected to, allowing it to assume a corresponding configuration. For example, it can be provided that the electronic module 10 has supplementary functions when it is connected to the second connection module 14.

With the modular construction of the microelectronic system, the electronic module 10 can be provided for multiple applications. For one, the electronic module 10 can be used in a “wearable electronics” article of clothing. For another, using the second connection module 14 a stand-alone operation is enabled. This offers the advantage that the costly components, i.e. the electronic module, need to be provided only once, and can be integrated into various applications. Especially when the user acquires multiple “wearable electronics” articles of clothing, only the first connection module 12 and the textile interface components need to be provided in the article of clothing. The electronic module 10 can be used in each of the various articles of clothing.

### LIST OF REFERENCE FIGURES

10 Electronic module
12 First connection module
14 Second connection module
16 Connector
18 Sealing ring
20 Mounting device
22 Socket
24 Control elements
26 Display
28 Socket
30 Textile cable
30 Textile cable

1-9. (canceled)

10. A modular microelectronic system, comprising:
a first connection module, which can be firmly connected to user interface devices integrated into a textile material;
a second connection module, which includes user interface devices and/or can be connected to an external device; and
an electronic module, which can be connected to the first connection module or to the second connection module.

11. The system of claim 10, wherein the electronic module comprises a processor element, a power supply unit, and a junction unit for connecting with one of the connection modules.

12. The system of claim 10, wherein the electronic module is designed to be essentially waterproof.

13. The system of claim 11, wherein the electronic module is designed to be essentially waterproof.

14. The system of claim 10, wherein the electronic module comprises an identification device designed to recognize which connection module the electronic module is connected to in a connected state.

15. The system of claim 11, wherein the first connection module and the second connection module each comprise a junction device that can accommodate the junction unit of the electronic module.

16. The system of claim 10, wherein the first connection module is designed to be essentially waterproof.

17. The system of claim 10, further comprising a mounting device configured to attached the first connection module to the textile material.

18. The system of claim 10, wherein the second connection module is designed such that when the second connection module is connected to an external device, a charging of the power supply unit of the electronic module and/or a transfer of data to and/or from the electronic module is enabled.

19. The system of claim 10, further comprising a charging device for charging the power supply unit of the electronic module, which can be connected to the electronic module and/or to the second connection module.
